(19) United States
(12) Patent Application Publication
(10) Pub. No.: US 2006/0111502 A1
(43) Pub. Date: May 25, 2006

(54) Teak deck caulking

(76) Inventors: Daan Y. Groeneveld, Nieuwegein (NL); Nancy Harman, Savannah, GA (US)

Correspondence Address: INTERNATIONAL PAPER COMPANY, 6285 TRI-RIDGE BOULEVARD, LOVELAND, OH, 45140, US

(21) Appl. No.: 11/252,449

(22) Filed: Oct. 18, 2005

Related U.S. Application Data
(60) Provisional application No. 60/619,915, filed on Oct. 18, 2004.

(51) Int. Cl. C08L 91/08; C08K 3/04

(52) U.S. Cl. 524/495; 524/487

(57) ABSTRACT

The invention relates to compositions and adhesives having good flexibility, good temperature resistance, good weathering resistance, good UV-resistance and good sandability, as well as methods of making and using the same.

The present application claims the benefit of priority under 35 USC §1 19(e) to U.S. Provisional Patent Application 60/619,915, which is hereby incorporated, in its entirety, herein by reference.

### FIELD OF THE INVENTION

The invention relates to compositions and adhesives having good flexibility, good temperature resistance, good weathering resistance, good UV-resistance and good sandability, as well as methods of making and using the same.

### DESCRIPTION OF THE RELATED ART

In the past, adhesives having good flexibility, good temperature resistance, good weathering resistance, good UV-resistance and good sandability have been difficult to produce. Such adhesives are highly desirable in the construction of boating structures, such as boat decks. Further, it has been extremely difficult to apply and make such adhesives having the above-mentioned highly desirable attributes.

According to Gerd Habenicht “Kleben, Grundlagen, Technologie, Anwendungen”, 3rd edition, 1997 it is still necessary to surface treat polyethylene or polypropylene substrates before bonding by mechanical pretreatments like sanding or sanding and coating (SACO-process), flaming, corona-treatment, low pressure plasma, fluorinating, chemical etching or preapplying of primers.

U.S. Pat. No. 4,791,164 discloses hotmelt adhesives compositions which may be used for bonding nonpolar polymers like polyethylene or polypropylene with considerable strength without the otherwise usual pretreatments as mentioned above. These hotmelt adhesives comprise blends of polyamides consisting essentially of the reaction product of dimerized fatty acid, aliphatiac dicarboxylic acid, monomeric fatty acid and aliphatic diamines plus terpolymer based on ethylene. This terpolymer is based on ethylene and/or propylene, an ethylenically unsaturated anhydride of carboxylic acid and a C₁-C₁₈ alkyester of acrylic or methacrylic acid.

U.S. Pat. No. 4,912,196 suggests hotmelt adhesives compositions for difficult-to-bond plastic materials such as polyvinyl chloride, polyesters, polyethylene and metals. According to U.S. Pat. No. 4,912,196 blends of thermoplastic polyamide resins consisting of polycondensates of a dimer fatty acid or mixture of such acids, a polyoxyalkylene urea diamine, aliphatic C.sub.6 -C.sub.40 diamine or a mixture of such diamines result in suitable hotmelt adhesive compositions for such substrates. Polyoxyakylene urea diamines are difficult to obtain in the market. Moreover, although these compositions give good adhesion to polyethylene in shear, their peel adhesion is poor.

U.S. Pat. No. 5,548,027 discloses hotmelt compositions for bonding non-pretreated polyethylene. In this reference compatible mixtures of at least one polyamide based on dimerized fatty acid, at least one copolymer of ethylene with at least one member selected from the group consisting of vinylacetate, acrylate and copolymers, block copolymers of styrene with ethylene isoprene butadiene and butylene and at least one plasticizer are suggested to solve this problem. The polyamide based on dimerized fatty acid may contain only very small amounts of trimeric fatty acid. This implies that only distilled dimer acid can be used. Although these adhesive compositions display very good adhesive properties both in tensile strength as well as in peel strength, they are expensive due to the fact that specific copolymers and purified dimer acids are required for making these adhesives.

According to EP-A-0 045 383, it is essential to use dimerized fatty acid with a very high content, preferably more than 90% by weight of dimer fatty acid and only a very small amount of trimeric fatty acid. According to EP-A-0 045 383 no more than 6% by weight of trimeric fatty acid should be present in the mixture.

According to U.S. Pat. No. 6,670,442, one is able to utilize crude mixtures of dimerized fatty acids and a diamine component that, in part, is an aliphatic diamine with at least 4 carbon atoms within a hot-melt adhesive composition that is capable of bonding untreated poly-α-olefins.

In all of the above potential solutions, the optimal balance of the cost of producing adhesive with good flexibility, good temperature resistance, good weathering resistance, good UV-resistance and good sandability has not been achieved, especially when attempting to make such a high-performance adhesive for use in constructing structures such as ships, boats, decks, etc, that are made from materials such as wood and more specifically teak wood.

### SUMMARY OF THE INVENTION

The present invention relates, in part, to a composition containing an acid component and an amine component, wherein the acid component may contain at least saturated or unsaturated, monocarboxylic aliphatic hydrocarbon or derivative thereof having a linear, branched, and/or cyclic chain, a dimer thereof, a trimer thereof, or mixtures thereof, at least one C₄ to C₁₂ dicarboxylic acid and at least one monocarboxylic acid with up to 20 carbon atoms; and the amine component may contain at least one aliphatic diamine with a number of carbon atoms in the chain of at least 2 whereby the amino groups at the terminal ends of the carbon chain, at least one organic diamine selected from the group of cyclic diamines and heterocyclic diamines, and at least one polyoxyalkylene-diamine, as well as methods of making and using the same.

The present invention further relates, in part, to an adhesive or caulking made from the above composition, as well as methods of making and using the same.

### DESCRIPTION OF THE PREFERRED EMBODIMENTS

The present inventors have discovered adhesives having good flexibility, good temperature resistance, good weathering resistance, good UV-resistance and good sandability, as well as methods of making and using the same. The present inventors have also discovered a composition that can be utilized as a caulking for building materials. This present invention relates, in part, to a composition, caulking and/or adhesive containing an acid component and an amine component. The acid component and amine component may be reactants which may also include additional optional components mentioned hereinbelow. The present invention further relates to methods of making and/or using the composition, caulking and/or adhesive.

The acid component may be present in an amount that is from 1 to 99 wt %, preferably greater than 50 wt %, including 1, 5, 10, 20, 30, 40, 50, 55, 60, 65, 70, 75, 80, 85, 90, and 95 wt %, including any and all ranges and subranges therein.

The amine component may be present in an amount that is from 1 to 99 wt %, preferably less than 50 wt %, including 1, 5, 10, 15, 20, 25, 30, 35, 40, 45, 50, 55, 60, 65, 70, 75, 80, 85, 90, and 95 wt %, including any and all ranges and subranges therein.

The present invention relates to a composition containing or having a reactant that is at least one saturated or unsaturated, monocarboxylic aliphatic hydrocarbon. The saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing or having a reactant that is at least one saturated or unsaturated, monocarboxylic aliphatic hydrocarbon or derivative thereof. Since the hydrocarbon is monocarboxylic, the derivative may be any commonly known derivative of a carbonyl-containing compound known in general Organic Chemistry Textbooks, such as “Organic Chemistry”, 5th Edition, by Leroy G. Wade, which is which is hereby incorporated, in its entirety, herein by reference.

Examples of derivatives of the saturated or unsaturated, monocarboxylic aliphatic hydrocarbon may be an ester, nitrile, or amine carboxylate thereof, as well as those commonly found in black liquor solids, soaps, skimmings, as well as tall oil products such as pitch and/or distillate products thereof. Again, the saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing or having a reactant that is at least one saturated or unsaturated, monocarboxylic aliphatic hydrocarbon or derivative thereof having a linear, branched, and/or cyclic chain. Again, the saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing or having a reactant that is at least one saturated or unsaturated, monocarboxylic aliphatic hydrocarbon or derivative thereof having a linear, branched, and/or cyclic chain, a dimer thereof, a trimer thereof, or mixtures thereof. The composition may contain from 0.1 to 99.9 wt % saturated or unsaturated, monocarboxylic aliphatic hydrocarbon or derivative thereof having a linear, branched, and/or cyclic chain, a dimer thereof, a trimer thereof, or mixtures thereof based upon the total weight of the composition. If the saturated or unsaturated, monocarboxylic aliphatic hydrocarbon or derivative thereof having a linear, branched, and/or cyclic chain, a dimer thereof, a trimer thereof, or mixtures thereof is part of an antifoam composition, then the antifoam composition from 0.1 to 99.9 wt % saturated or unsaturated, monocarboxylic aliphatic hydrocarbon or derivative thereof having a linear, branched, and/or cyclic chain, a dimer thereof, a trimer thereof, or mixtures thereof based upon the total weight of the composition as well.

The amount of saturated or unsaturated, monocarboxylic aliphatic hydrocarbon or derivative thereof having a linear, branched, and/or cyclic chain, a dimer thereof, a trimer thereof, or mixtures thereof present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition, including any ranges and subranges therein. Preferably, the unsaturated, monocarboxylic aliphatic hydrocarbon is present or a reactant in an amount ranging from about 40 wt % to about 99 wt %, more preferably from about 45 wt % to about 85 wt %.

The saturated or unsaturated, monocarboxylic aliphatic hydrocarbon or derivative thereof having a linear, branched, and/or cyclic chain, a dimer thereof, a trimer thereof, may be any one or more found in biomass products, such as those similar to black liquor solids, soaps, skimmings, as well as tall oil products such as pitch and/or distillate products such as tall oil fatty acid, distilled tall oil, crude tall oil, and monomer.

The saturated or unsaturated, monocarboxylic aliphatic hydrocarbon is a fatty acid. Examples of such include oleic, linoliec and/or stearic acids, including a derivative thereof; a linear, branched, and/or cyclic isomer thereof; a dimer thereof; and/or a trimer thereof.

The saturated or unsaturated, monocarboxylic aliphatic hydrocarbon or derivative thereof having a linear, branched, and/or cyclic chain, a dimer thereof, a trimer thereof, may be an acid having linear, branched, and/or cyclic C₁₈ chain. Examples of such may include linoliec and/or oleic acids or derivative thereof. Further examples may be linear, branched, and/or cyclic isomers of linoliec and/or oleic acids.

Examples of the saturated or unsaturated, monocarboxylic aliphatic hydrocarbon or derivative thereof having a linear, branched, and/or cyclic chain, a dimer thereof, a trimer thereof may be those found and described, for example in U.S. Pat. Nos. 6,875,842; 6,846,941; 6,344,573; 6,414,111; 4,519,952; and 6,623,554, which are hereby incorporated, in their entirety, herein by reference.

Finally, examples of the saturated or unsaturated, monocarboxylic aliphatic hydrocarbon or derivative thereof having a linear, branched, and/or cyclic chain, a dimer thereof, a trimer thereof may be caproic, enthanic, caprylic, capric, isodecyl, pelargonic, lauric, myristic, palmitic, oleic, linoleic, linolenic, stearic, isostearic, behenic, arachidic, arachidonic, erucic, azelaic, coconut, soya, tall oil, tallow, lard, neatsfoot, apricot, wheat germ, corn oil, cotton seed oil, ricinic, ricinoleic, rapeseed, palm kernel fatty acids, dimer acids, trimer acids, ozone acids, diacids, triacids, combinations and mixtures of these.

Preferably, the present invention relates to a composition containing or having a reactant that is a dimer of the above at least one saturated or unsaturated, monocarboxylic aliphatic hydrocarbon. The dimer preferably may be any dimerized fatty acid obtained by oligomerizing or polymerizing unsaturated long-chain monobasic fatty acids such as for example linoleic acid or oleic acid. These polymeric acids have long been known and are commercially available. Specific examples may be those selected from Arizona Chemical Company, for example, Unidyme 18. Dimer acids are known to be a mixture of several isomers and oligomers. Prior to purification, such crude mixtures of polymeric fatty acids have approximately the following composition:

| | |
|---|---|
| monomeric acids | about 5-15% by weight |
| dimeric acids | about 60-80% by weight |
| polymeric acids including trimeric acids | about 10-50% by weight. |

These crude polymeric fatty acids are normally purified by distillation and sometimes subsequent hydrogenation. When purified, the dimer acid may contain from 0-15% by weight monomeric acids. This range includes 0.5, 1, 1.5, 2.0, 2.5, 3, 3.5, 4, 4.5, 5, 6, 7, 8, 9, 10, 11, 12, 13, 14 and 15 wt % by weight monomeric acids, including any ranges and subranges therein. When purified, the dimer acid may contain from 60-100% by weight dimeric acids.

This range includes 60, 65, 70, 75, 80, 85, 90, 95, and 100%, including any ranges and subranges therein. When purified, the dimer acid may contain from 0 to 50% by weight polymeric acids including trimeric acids. This range includes 0.5, 1, 1.5, 2.0, 2.5, 3, 3.5, 4, 4.5, 5, 6, 7, 8, 9, 10, 11, 12, 13, 14, 15, 16, 17, 20, 25, 30, 35, 40, 45, and 50% by weight polymeric acids including trimeric acids, including any ranges and subranges therein.

The present invention relates to a composition containing or having a reactant that is at least one acid component may contain C₄ to C₁₂ dicarboxylic acids and monocarboxylic acids with up to 20 carbon atoms. Examples of suitable dicarboxylic acids are maleic acid, succinic acid, adipic acid, azelaic acid, sebacic acid, dodecane-dioic acid, glutaric acid, suberic acid, pimelic acid or aromatic dicarboxylic acids, e.g. terephthalic acid or mixtures of these dicarboxylic acids. Examples of monocarboxylic acids may be stearic and isostearic acid which are commercially available, for example from Arizona Chemical Company as Century 1105 and 1224, respectively.

The present invention relates to a composition containing or having a reactant that is at least one acid component containing, in part, at least one C₄ to C₁₂ dicarboxylic acid and/or at least one monocarboxylic acid in an amount ranging from 0 to 99 wt %, more preferably from 0.1 to 50 wt %, most preferably from 0.1 to 10 wt %. If there is a mixture of C₄ to C₁₂ dicarboxylic acids and monocarboxylic acids, preferably the all of the components are present in an amount that is less than 10 wt % for each, respectively. These amounts of C₄ to C₁₂ dicarboxylic acids and monocarboxylic acids in the acid component include 0, 1, 2, 3, 4, 5, 6, 7, 8, 9, 10, 11, 12, 13, 14, 15, 20, 25, 30, 35, 40, 45, 50, 55, 60, 65, 70, 75, 80, 85, 90, and 95 wt %, including any and all ranges and subranges.

Finally, the acid component may contain an inorganic acid. An example of an inorganic acid is phosphoric acid, including different hydration levels thereof. The amount of the inorganic acid may be from 0 to 10 wt %, including 0.001, 0.005, 0.01, 0.02, 0.03, 0.04, 0.05, 0.06, 0.07, 0.08, 0.09, 0.1, 0.2, 0.3, 0.4, 0.5, 1, 2, 3, 4, 5, 6, 7, 8, 9 and 10 wt %, including any and all ranges and subranges therein.

The “wt %”0 mentioned above and below is based upon the total weight of the composition, adhesive, caulking, including the acid component, amine component, and any optional components mentioned below and/or above, unless specifically stated otherwise.

The amine component may contain at least one amine-containing compound. Preferably, the amine containing compound is at least one diamine. The amine component may include at least one aliphatic diamine with a number of carbon atoms in the chain of at least 2 whereby the amino groups are preferably at the terminal ends of the carbon chain. The aliphatic diamines may contain up to 20 carbon atoms and the aliphatic chain may be essentially linear or branched. The most amine containing compound is ethylenediamine.

The composition may contain from 0 to 99 wt %, preferably from 0.1 to 50 wt %, more preferably from 0.5 to 30 wt %, most preferably from 1 to 10 wt %, of at least one aliphatic diamine with a number of carbon atoms in the chain of at least 2 whereby the amino groups are preferably at the terminal ends of the carbon chain. These ranges include 0, 0.1, 0.5, 1, 2, 3, 4, 5, 6, 7, 8, 9, 10, 15, 20, 25, 30, 35, 40, 50, 60, 70, 80, and 90 wt % ofat least one aliphatic diamine with a number of carbon atoms in the chain of at least 2 whereby the amino groups are preferably at the terminal ends of the carbon chain, including any and all ranges and subranges therein.

The amine component may contain at least one organic diamine selected from the group of cyclic diamines and heterocyclic diamines. Examples for cyclic (aliphatic) diamines or heterocyclic diamines are cyclohexanediamine, 4,4′-diamino-dicyclohexyl-methane, xylenediamine, piperazine, cyclohexanebis(methylamine), isophorone diamine, dimethylpiperazine and dipiperidylpropane, dimer diamines (amines derived from dimer acids e. g. sold by Henkel under the trade name “Versamine”). Preferably, the organic cyclic diamine is piperazine.

The composition may contain from 0 to 99 wt %, preferably from 0.1 to 50 wt %, more preferably from 0.5 to 30 wt %, most preferably from 1 to 10 wt %, of at least one organic diamine selected from the group of cyclic diamines and heterocyclic diamines. These ranges include 0, 0.1, 0.5, 1, 2, 3, 4, 5, 6, 7, 8, 9, 10, 15, 20, 25, 30, 35, 40, 50, 60, 70, 80, and 90 wt % of at least one organic diamine selected from the group of cyclic diamines and heterocyclic diamines, including any and all ranges and subranges therein.

The amine component may contain at least one polyoxyalkylene-diamine, for example polyoxyethylene diamine, polyoxypropylenediamine or bis-(di-aminopropyl)-polytetrahydrofurane. The polyoxyalkylenediamines, also known as “Jeffamines” (tradename of Huntsman), are most preferred. Typically, their molecular weight ranges between 200 and 4,000 preferably between 400 and 2,000. Their molecular weight may by 200, 250, 300, 350, 400, 500, 600, 700, 800, 900, 1000, 1100, 1200, 1300, 1400, 1500, 1600, 1700, 1800, 1900, 2000, 2200, 2500, 2700, 3000, 3200, 3500, 3700, and 4000, including any and all ranges and subranges therein. The molecular weights mentioned above are approximate number average molecular weighst.

The composition may contain from 0 to 99 wt %, preferably from 1 to 70 wt %, more preferably from 1 to 50 wt %, most preferably from 5 to 40 wt %, of at least one polyoxyalkylene-diamine. These ranges include 0, 0.1, 0.5, 1, 2, 3, 4, 5, 6, 7, 8, 9, 10, 15, 20, 25, 30, 35, 40, 50, 60, 70, 80, and 90 wt % of at least one polyoxyalkylene-diamine, including any and all ranges and subranges therein.

The amine component comprises preferably 1 to 10 wt % of the at least one aliphatic diamine and 1 to 10 wt % of the at least one cyclic diamine and 3 to 30 wt % of the at least one polyoxyalkylene diamine. The wt % are based upon the total weight of the composition, adhesive, caulking and/or reactants, including the acid component and any additional optional components discussed above and/or below.

The composition may contain optional components such as organic Fillers such as nut shell, bark and wood flours and lignin, calcium carbonate, aluminum trihydrate, aluminum oxide, talc (magnesium silicate hydrate), Kaolin or clay, graphite, carbon black, glass fibers, antioxidant, at least one catalyst, at least one processing aid, wax, coloring agent and/or at least one solvent such as water, and/or TiO2.

The above mentioned optional additives may be added in any amount that enables them to perform their function, yet does not destroy the above and/or below mentioned desirable result-dependent and physical characteristics of the composition according to the present invention. Therefore, they may each individually and/or combined add up to from 0 to 99 wt % based on the total weight of the composition. This range includes 0, 0.1, 0.5, 1, 2, 3, 4, 5, 6, 7, 8, 9, 10, 15, 20, 25, 30, 35, 40, 50, 60, 70, 80, and 90 wt % of at least optional component, including any and all ranges and subranges therein.

The polyamide resins according to the invention may be prepared by conventional condensation methods and the acid components and amine components are present in approximate stoichiometric quantities. In the majority of cases it is preferred that residual acid groups or residual amino groups be present after the condensation. To achieve this, an excess of acid or base of no more than 10 equivalent % of the sum of all functional groups is used. Instead of the free carboxylic acids, their corresponding methyl-, ethyl or propyl-ester may be used in the condensation reaction. The melt viscosity of the polyamide-composition may be controlled by adding a small amount of a monofunctional carboxylic acid like stearic acid.

The composition of the present invention may be a reaction composition, adhesive composition, a caulking composition. Such adhesives may be a hot-melt adhesive composition which may be made from the above composition or reactants.

The polyamides of the present invention can be prepared by methods known in the art, for example by the general method disclosed in U.S. Pat. No. 4,912,196 examples 1-3.

The polyamide hotmelt adhesives are applied using conventional hotmelt application procedures such as spraying, print dipping, molding, spreading, rolling and the like. While for most constructions the resin is applied to only one side of the substrate, it may be applied to both sides in order to form a sandwich-type construction. Preferably, the polyamides of the present invention are the sole polymeric ingredient of the hotmelt adhesive, however, they may also be blended with other polyamides and/or other polymers. They may also contain other conventional additives like tackifiers, antioxidants, fillers and other common auxiliaries for hot melt adhesives.

Such application devices may include any of those specifically designed to apply hot-melt polyamides that are conventional and/or that are specifically tailored to delivering the composition of the present invention to a building material, such as a boat construction material, more specifically a boat deck construction material. An example of a boat deck construction material is wood, such as teak wood.

The composition of the present invention may also contain additives that increase its sandability, yet maintain good flexibility. Any conventional additive to adhesive may be utilized so long as the composition maintains the below-mentioned favorable physical properties.

The composition of the present invention should have excellent sandability, good flexibility and good adhesion. Therefore, it is desired that the composition have a softening point typically from 100° C. to 200° C. (determined in accordance with ASTM-E-28 for example), preferably 120° C. to 140° C. (ideally from 125 to 135 ° C.), including all ranges and subranges therein. Also, it is desired that the composition have a viscosity of from 1000 to 10000 mPa·s, more preferably from 3000 to 8000 mPaS, as measured at 190° C. (ideally from 3000 to 5000 mPaS), including all ranges and subranges therein as measured by ASTM D3236, for example.

In addition, the elastic modulus of the composition should be from 1 to 10 MPa, preferable from 2 to 4 MPa, including all ranges and subranges therein. Also, the tensile strength of the composition should be from about 0.5 to 2.0 MPa, more preferably from 0.75 to 1.25 MPa and most preferable about 1.0 MPa, including all ranges and subranges therein. Also, the elongation of the composition should be greater than 50%, preferably greater than 100%, most preferably greater than 200%, including all ranges and subranges therein.

The present invention is explained in more detail with the aid of the following embodiment examples.

The improved bonding properties of the compositions, adhesives and caulkings of the present invention to untreated teak wood substrates can be further illustrated by the following examples. It is to be understood that the examples are only to be considered as an illustration of one embodiment of the invention and that modifications throughout may occur to those skilled in the art.

### EXAMPLES

A TRL (Bostik-Findley) hot melt polyamide was blended with about 10% of graphite. The resin met the requirements of an adhesive having good flexibility, good temperature resistance, good weathering resistance, good UV-resistance. However, such a composition did not have the sandability required, causing the resin to smear when applied to deck construction material such as teak wood.

Uni-Rez 2645, a polyamide was blended with Thermelt 830, a different polyamide. After a trial and error period he found that a blend of Uni-Rez 2645 and Thermelt 830 in a ratio of 2:1 provided the sandability required and some associated flexibility when applied to deck construction material such as teak wood.

Composition AA0272-92 outlined below was blended in a 2:1 ratio with Uni-Rez 2645 and the addition of 7.5% w/w graphite (423 Graphite Powder supplied by Wessex Resins and Adhesives Ltd., UK). The composition demonstrated reasonable sandability with having good flexibility, good temperature resistance, good weathering resistance, good UV-resistance, when applied to deck construction material such as teak wood.

A newly developed composition, AA0272-96 resin outlined below, neat and blended with the graphite was also produced and tested. This composition had adhesion, flexibility and sandability that was excellent. Also, the graphite blended material performed better than the neat resin when applied to deck construction material such as teak wood.

The AA0272-96 resin outlined below was modified slightly to lower the residual amine number to a value below 7. The newly developed resin, designated AA0272-98 outlined below had excellent adhesion, flexibility and sandability when applied to deck construction material such as teak wood.

The Formulation (weight %) AA0272-92:

TABLE 1

| Raw Material | | | Final Weight (%) |
|---|---|---|---|
| (initial batch | | Corrections | (Final Batch |
| size 909 g) | Weight % | Weight (g) | size 923.6 g) |
| Unidyme 18 | 79.40 | 14.6 | 79.73 |
| Adipic Acid | 2.98 | | 2.94 |
| Phosphoric Acid | 0.01 | | 0.01 |
| Ethylenediamine | 3.76 | | 3.71 |
| Piperazine (100%) | 7.39 | | 7.27 |
| Jeffamine D-2000 | 5.46 | | 5.37 |
| Anox ODS | 0.5 | | 0.49 |
| Anox 20 | 0.5 | | 0.49 |

The Formulation (weight %) UR2645:

TABLE 2

| Raw Material | Weight % |
|---|---|
| Unidyme 18 | 75.50 |
| Azelaic Acid | 9.40 |
| Phosphoric Acid | 0.01 |
| Ethylenediamine | 4.96 |
| Piperazine (100%) | 8.09 |
| Anox ODS | 1.02 |
| Anox 20 | 0.51 |
| M-5194 (Wax) | 0.51 |

The Formulation (weight %) AA0272-96:

TABLE 3

| Raw Material | | | Final Weight (%) |
|---|---|---|---|
| (initial batch | | Corrections | (Final Batch |
| size 909 g) | Weight % | Weight (g) | size 1042.1 g) |
| Unidyme 18 | 62.78 | 4.7 | 55.22 |
| Sebacic Acid | 7.47 | | 6.51 |
| Stearic Acid | 1.44 | | 1.26 |
| Phosphoric Acid | 0.01 | | 0.01 |
| Ethylenediamine | 3.96 | | 3.45 |
| Piperazine (100%) | 7.34 | | 6.40 |
| Jeffamine D-2000 | 16.00 | 128.4 | 26.29 |
| Anox ODS | 0.5 | | 0.43 |
| Anox 20 | 0.5 | | 0.43 |

AA0272-96 served as the start formulation for AA0272-98. The high content of Jeffamine D-2000 not only gives the product the flexibility needed but also contributes to good sandability, with or without the presence of graphite.

AA0272-98 (weight %):

TABLE 4

| Raw Material | | | Final Weight (%) |
|---|---|---|---|
| (initial batch | | Corrections | (Final Batch |
| size 913.5 g) | Weight % | Weight (g) | size 918.2 g) |
| Unidyme 18 | 54.30 | 4.7 | 54.54 |
| Sebacic Acid | 6.75 | | 6.71 |
| Stearic Acid | 1.79 | | 1.78 |
| Isostearic Acid | 1.79 | | 1.78 |
| Phosphoric Acid | 0.01 | | 0.01 |
| Ethylenediamine | 2.98 | | 2.96 |
| Piperazine 100% | 7.22 | | 7.18 |
| Jeffamine D-2000 | 23.69 | | 23.57 |
| Anox ODS | 0.49 | | 0.49 |
| Anox 20 | 0.49 | | 0.49 |
| M-5194 (Wax) | 0.49 | | 0.49 |

1. Anox ODS and Anox 20 are standard anti-oxidants used in the Uni-Rez hot melt polyamide products in Europe.
2. Phosphoric Acid is a catalyst.
3. Microwax M-5194 is a processing aid.
4. Jeffamine D-2000 is a polyoxyalkylenediamine from Huntsman
5. The weight % includes the water of reaction, typically around 5% by weight.

TABLE 5
Formula: AA0272-98US

| | Charge | Weight | Equiv. | Percent | Acid | Gram |
|---|---|---|---|---|---|---|
| Component | Weight | Percent | Weight | Equiv. | Cont. | Equiv. |
| UNIDYME 18 | 554.30 | 55.43 | 291.00 | 69.80 | 106.86 | 0.1905 |
| SEBACIC | 73.11 | 7.31 | 101.10 | 26.50 | 40.57 | 0.0723 |
| CENTURY 1105 (ISOSTE | 15.36 | 1.54 | 268.00 | 2.10 | 3.21 | 0.0057 |
| CENTURY 1224 | 11.87 | 1.19 | 290.00 | 1.50 | 2.30 | 0.0041 |
| PHOSPHORIC ACID | 0.09 | 0.01 | 32.67 | 0.10 | 0.15 | 0.0003 |
| ETHYLENEDIAMINE | 30.30 | 3.03 | −30.20 | 36.77 | −56.29 | 0.1003 |
| PIPERAZINE 100% | 73.52 | 7.35 | −43.07 | 62.55 | −95.76 | 0.1707 |
| JEFFAMINE D-2000 | 241.45 | 24.14 | −1000.00 | 8.85 | −13.55 | 0.0241 |

TABLE 6
Formula: AA0272-98EU

| | Charge | Weight | Equiv. | Percent | Acid | Gram |
|---|---|---|---|---|---|---|
| Component | Weight | Percent | Weight | Equiv. | Cont. | Equiv. |
| UNIDYME 18 | 550.26 | 55.03 | 291.00 | 69.90 | 106.08 | 0.1891 |
| SEBACIC | 68.37 | 6.84 | 101.10 | 25.00 | 37.94 | 0.0676 |
| CENTURY 1105 (ISOSTE | 18.12 | 1.81 | 268.00 | 2.50 | 3.79 | 0.0068 |
| CENTURY 1224 | 19.61 | 1.96 | 290.00 | 2.50 | 3.79 | 0.0068 |
| PHOSPHORIC ACID | 0.09 | 0.01 | 32.67 | 0.10 | 0.15 | 0.0003 |
| ETHYLENEDIAMINE | 30.15 | 3.01 | −30.20 | 36.90 | −56.00 | 0.0998 |
| PIPERAZINE 100% | 73.15 | 7.32 | −43.07 | 62.78 | −95.28 | 0.1698 |
| JEFFAMINE D-2000 | 240.24 | 24.02 | −1000.00 | 8.88 | −13.48 | 0.0240 |

### RESULTS

An overview of the properties of the above-mentioned compositions is given below:

| | Thermelt 830: | AA0272-92: | |
|---|---|---|---|
| | UR2645 | UR2645 | AA0272-98 |
| Viscosity @ 190° C. | 4600 | 5750 | 4100 |
| (mPas) | | | |
| Softening Point (° C.) | 134 | 134 | 126 |
| Tensile Strength (MPa) | 3.9 | 1.93 | 1.1 |
| Elongation (%) | 524 | 510 | 227 |
| Modulus (MPa) | 25.2 | 8.22 | 2.1 |

As used throughout, ranges are used as a short hand for describing each and every value that is within the range, including all subranges therein.

Numerous modifications and variations on the present invention are possible in light of the above teachings. It is, therefore, to be understood that within the scope of the accompanying claims, the invention may be practiced otherwise than as specifically described herein.

The present application is related to PCE Application Number PCT/EP2005/051561 filed on Apr. 8, 2005, which is hereby incorporated, in its entirety, herein by reference.

All of the references, as well as their cited references, cited herein are hereby incorporated by reference with respect to relative portions related to the subject matter of the present invention and all of its embodiments

We claim:

1. A composition, comprising
an acid component and an amine component, wherein the acid component comprises at least saturated or unsaturated, monocarboxylic aliphatic hydrocarbon or derivative thereof having a linear, branched, and/or cyclic chain, a dimer thereof, a trimer thereof, or mixtures thereof, at least one C₄ to C₁₂ dicarboxylic acid and at least one monocarboxylic acid with up to 20 carbon atoms; and the amine component comprises at least one aliphatic diamine with a number of carbon atoms in the chain of at least 2 whereby the amino groups at the terminal ends of the carbon chain, at least one organic diamine selected from the group of cyclic diamines and heterocyclic diamines, and at least one polyoxyalkylene-diamine.

2. The composition according to claim 1, further comprising a carbon black, graphit, or mixtures thereof.

3. The composition according to claim 1, further comprising an inorganic acid

4. The composition according to claim 1, further comprising phosphoric acid.

5. The composition according to claim 1, further comprising an antioxidant

6. The composition according to claim 1, further comprising a wax.

7. The composition according to claim 1, wherein the at least one saturated or unsaturated, monocarboxylic aliphatic hydrocarbon or derivative thereof having a linear, branched, and/or cyclic chain, a dimer thereof, a trimer thereof, or mixtures thereof is a dimer acid.

8. The composition according to claim 7, wherein the dimer acid comprises monomeric acid, dimeric acid, and trimeric acid.

9. The composition according to claim 7, wherein the at least one C₄ to C₁₂ dicarboxylic acid is adipic acid, sebacic acid or mixtures thereof.

10. The composition according to claim 1, wherein the at least one monocarboxylic acid with up to 20 carbon atoms is stearic acid, isostearic acid, or mixtures thereof.

11. The composition according to claim 1, wherein the at least one aliphatic diamine with a number of carbon atoms in the chain of at least 2 whereby the amino groups at the terminal ends of the carbon chain is ethylenediamine.

12. The composition according to claim 1, wherein the at least one organic diamine selected from the group of cyclic diamines and heterocyclic diamines is piperazine.

13. The composition according to claim 1, wherein the at least at least one polyoxyalkylene-diamine has a number average molecular weight of from about 200 to about 4,000.

14. The composition according to claim 1, wherein the at least at least one polyoxyalkylene-diamine is Jeffamine and has a number average molecular weight of from about 500 to about 3,000.

15. The composition according to claim 1, wherein the at least one saturated or unsaturated, monocarboxylic aliphatic hydrocarbon or derivative thereof having a linear, branched, and/or cyclic chain, a dimer thereof, a trimer thereof, or mixtures thereof comprises from about 0 to about 15 wt % monomeric acid, from about 60 to about 100 wt % dimeric acid, and from about 0 to about 50 wt % polymeric acid.

16. The composition according to claim 15, wherein the at least one monocarboxylic acid with up to 20 carbon atoms is stearic acid, isostearic acid, or mixtures thereof.

17. The composition according to claim 15, wherein the at least one aliphatic diamine with a number of carbon atoms in the chain of at least 2 whereby the amino groups at the terminal ends of the carbon chain is ethylenediamine.

18. The composition according to claim 15, wherein the at least one organic diamine selected from the group of cyclic diamines and heterocyclic diamines is piperazine.

19. The composition according to claim 15, wherein the at least at least one polyoxyalkylene-diamine has a number average molecular weight of from about 200 to about 4,000.

20. The composition according to claim 15, wherein the at least at least one polyoxyalkylene-diamine is Jeffamine and has a number average molecular weight of from about 500 to about 3,000.
